(19) United States
(12) Patent Application Publication
(10) Pub. No.: US 2016/0033354 A1
(43) Pub. Date: Feb. 4, 2016

(54) METHOD AND DEVICE FOR LEAK DETECTION AND LOCATION FOR FLUID PIPELINES

(71) Applicant: Chongqing University, Chongqing (CN)

(72) Inventors: Ping Li, Chongqing (CN); Yumei Wen, Chongqing (CN); Shuaiyong Li, Chongqing (CN); Jing Wen, Guiyang City (CN); Jing Qiu, Chongqing (CN); Jin Yang, Chongqing (CN)

(73) Assignee: Chongqing University

(21) Appl. No.: 14/558,726

(22) Filed: Dec. 3, 2014

(30) Foreign Application Priority Data
Jul. 31, 2014 (CN) 201410373753.7

(51) Int. Cl. G01M 3/24

(52) U.S. Cl. CPC G01M 3/243

(57) ABSTRACT

The present invention discloses a method for leak detection and location for fluid pipelines, comprising a pipeline to be detected, characterized in that the pipeline to be detected is at least provided with two sensing devices having a certain distance therebetween. Acquisition points are formed at the positions of the sensing devices. The sensing devices can simultaneously sense acoustic vibrations of the pipeline in two directions, i.e., axial direction and radial direction of the pipeline, respectively. When there is a leak point in the pipeline to be detected between the two acquisition points, locating the leak point is performed according to the following formula:

$$\{ \begin{matrix}{τ}_{L 12} {V}_{L} + {l}_{1} - {l}_{2} = 0 \\ {τ}_{T 12} {V}_{T} + {l}_{1} - {l}_{2} = 0 \\ {τ}_{2} {l}_{1} - {τ}_{1} {l}_{2} = 0 \\ {l}_{1} + {l}_{2} = L .\end{matrix}$$

The present invention has the advantages of high location accuracy without needing to know the wave velocity of acoustic vibrations of the pipeline, and low processing complexity; and the acoustic velocities of longitudinal and transverse waves of the pipeline can be measured actually.

### CROSS-REFERENCE TO RELATED APPLICATIONS

This application is a continuation of, and claims priority to, Chinese Patent Application No. 201410373753.7 with a filing date of Jul. 31, 2014. The content of the aforementioned application, including any intervening amendments thereto, is incorporated herein by reference.

### BACKGROUND OF THE INVENTION

The present invention relates to the leak location technology for pipelines, and particularly to a method and device for leak detection and location for fluid pipelines.

During leak detection and location for fluid pipelines, the most common method employed (the most commonly used method) is the correlation peak location method (cross-correlation method). The correlation peak location method is specifically as follows: a plurality of acquisition points are set on a pipeline to be detected, and an acoustic sensor or a vibration sensor is provided at each of the acquisition points (several acoustic sensors or vibration sensors are set at either sides of suspect leakages on a pipeline to be detected); during detection, cross-correlation is performed for output signals of two adjacent sensors, if the output signals of the two sensors have an obvious correlation peak, it is indicated that there is a leak in the pipeline between the acquisition points where the two sensors are located (these two monitoring points), and the position of the correlation peak reveals the time delay of the two signals and can also be used to determine the leak location along with the propagation velocity of the acoustic vibration from the leak point in the pipeline.

The correlation location method is a pipeline leak location method based on time delay estimation. From the processing procedure, it is easy to find that the known propagation velocity of an acoustic vibration signal in the pipeline is a prerequisite for the implementation of this method. However, in actual (practical) engineering, due to the diversity of pipelines in materials and sizes, variability of buried conditions, ambiences and other factors, the propagation velocity of an acoustic vibration signal in different pipelines differs from one another, and even the propagation velocity of an acoustic vibration signal in different sections of an identical pipeline is also different. This undoubtedly increases the complexity and uncertainty in detection. In the state of art regarding pipeline leak detection, to simplify this problem, the actual acoustic velocities are generally replaced with theoretical values or estimated values. These may have a great difference with the actual acoustic velocity, resulting in a great error in principle, and the location accuracy based on the error will be greatly degraded with the increase of the length of a pipeline. Consequently, it is difficult to apply the correlation location method in the monitoring of pipelines with a large length (long-distance pipelines).

With regard to the problem mentioned above, those skilled in the art have researched and put forward some alternating solutions. For example, J. Yang et al. have proposed a blind system identification method to estimate the absolute time of transmission of each leak acoustic signal in a pipeline. This method may perform leak location for a fluid pipeline under the condition that the acoustic velocity of a leak signal is unknown, and may calculate the actual acoustic velocity of the pipeline. However, this method has complicated algorithm and heavy calculation, and requires that the collected signals should have a rather high signal-to-noise ratio for analysis; and consequentely the applicable distance for detection is quite short (J. Yang, Y. Wen and P. Li, Leak location using blind system identification in water distribution pipelines, Journal of Sound and Vibration 310(2008)134-148. J. Yang, Y. Wen and P. Li, The genetic-algorithm-enhanced blind system identification for water distribution pipeline leak detection, Measurement Science and Technology 18 (2007) 2178-2184.).

### SUMMARY OF THE PRESENT INVENTION

In view of the problems mentioned in the background art, the present invention provides a method for leak detection and location for fluid pipelines, characterized in that the pipeline to be detected is at least provided with two sensing devices having a certain distance there between, acquisition points are formed at the positions of the sensing devices, and the sensing devices can simultaneously sense acoustic vibrations of the pipeline in two directions, i.e., the axial direction and the radial direction of the pipeline, respectively; when there is a leak point in the pipeline to be detected between the two acquisition points, locating the leak point is performed according to the following methods:

suppose the two acquisition points are respectively acquisition point 1 and acquisition point 2, a distance between the two acquisition points is L, a distance from the acquisition point 1 to the leak point is l₁, a distance from the acquisition point 2 to the leak point is l₂, the propagation velocity of a longitudinal wave signal in the pipeline to be detected is V_{L}, and the propagation velocity of a transverse wave signal in the pipeline to be detected is V_{T}; the output of the sensing devices contains radial acoustic vibration signals and axial acoustic vibration signals, a time delay value of a maximum peak other than a time delay zero point of a cross-correlation function of a radial acoustic vibration signal and an axial acoustic vibration signal corresponding to the acquisition point 1 is τ₁, a time delay value of a maximum peak other than a time delay zero point of a cross-correlation function of a radial acoustic vibration signal and an axial acoustic vibration signal corresponding to the acquisition point 2 is τ₂, a time delay value of the maximum peak of a cross-correlation function of axial acoustic vibration signals of the two acquisition points is τ_{L12}, and a time delay value of the maximum peak of a cross-correlation function of radial acoustic vibration signals of the two acquisition points is τᵣ₁₂; and, the L is already known;

when τ_{L12}≠0, τᵣ₁₂≠0 and τ₁+τ₂≠0 are satisfied simultaneously, the position of the leak point is solved according to the following methods:

V_{L}, V_{Y}, l₁ and l₂ are solved by using the system of equations:

$$\{ \begin{matrix}{τ}_{L 12} {V}_{L} + {l}_{1} - {l}_{2} = 0 \\ {τ}_{T 12} {V}_{T} + {l}_{1} - {l}_{2} = 0 \\ {τ}_{2} {l}_{1} - {τ}_{1} {l}_{2} = 0 \\ {l}_{1} + {l}_{2} = L\end{matrix} ;$$

after V_{L}, V_{T}, l₁ and l₂ are solved, the position of the leak point may be acquired according to l₁ or l₂;

when any one of τ_{L12}=0, τ_{T12}=0 and τ₁+τ₂=0 is satisfied, the position of the leak point is found according to the following methods:

if τ_{L12}=0, τ_{T12}=0 and τ₁+τ₂≠0, the leak point is located at a middle point between the two acquisition points; if τ₁+τ₂=0, it is indicated that the distance between the two sensing devices is 0, and the leak point, the acquisition point 1 and the collection 2 are at an identical position.

Based on the location method described above, the present invention provides a device for leak location for fluid pipelines. As shown in FIG. 1, the device is provided with sensors, data acquisition units and a data processing center. When the sensors are dual-axis acoustic/vibration sensors, the two sensing directions of each of the sensors are perpendicular to each other, wherein the first sensing direction X is parallel to the axial direction of a pipeline, the second sensing direction Z is parallel to the radial direction of the pipeline, and the sensors are electrically connected to the data acquisition units one to one. When the sensors are single-axis acoustic/vibration sensors, every two acoustic/vibration sensors are arranged at one point in the pipeline, that is, form an acquisition point, and at each acquisition point: the sensing direction of one of the acoustic/vibration sensors is brought to be parallel to the axial direction of the pipeline, meanwhile, the sensing direction of the other one of the acoustic/vibration sensors is brought to be parallel to the radial direction of the pipeline, and the two sensors at each of the acquisition points are electrically connected to one data acquisition unit correspondingly. The data acquisition units may be in wired communication with the data processing center via a wired network or in wireless communication with the data processing center via a wireless network. The sensors, the data acquisition units and the data processing center described above constitute a device for leak location for pipelines.

The principle of the method described above is as follows:

in a pressure fluid pipeline, due to the motion of fluid in the pipeline and other reasons, there are three modes of pipeline vibration, i.e., longitudinal vibration, torsion and bending. These three modes are supposed as, and, respectively, where is also referred to as a longitudinal wave signal, and and are also referred to as transverse wave signals, is the position coordinate, and t is the time; and, a vibration signal at any position on the pipeline wall is formed from a longitudinal wave signal and a transverse wave signal.

A vibration signal propagated in the length direction of the pipeline (i.e., the axial direction of the pipeline) may be expressed by the following formula:

x(t)=L(t)+δ_{L}T(t)+ξ_{L}F(t) (1);

a vibration signal propagated in the radial direction of the pipeline may be expressed by the following formula:

z(t)=T(t)+δ_{T}L(t)+ξᵣF(t) (2);

in the formulae (1) and (2), both δ_{L} and δ_{T} are parameters determined by a Poisson's ratio of the material of a pipeline, representing the degree of transverse strain caused by the normal strain of the material, where δ_{L} is corresponding to the axial direction of the pipeline, δ_{T} is corresponding to the radial direction of the pipeline, and apparently, both δ_{L} and δ_{T} are less than 1; and, ξ_{L} and ξᵣ represent scale parameters of projections of the bending strain of the pipeline in the axial direction and in the radiation direction, respectively, and both ξ_{L} and ξᵣ are parameters less than 1.

According to the theory of correlation functions, a correlation function of an axial vibration signal x(t) and a radial vibration signal z(t) may be expressed by the following formula:

R(x(t),z(t+τ))=R(L(t),T(t+τ))+δ_{L}R(T(t),T(t+τ)+ξ_{L}R(F(t),T(t+τ))+δ_{T}R(L(t),L(t+τ))+δ_{L}δ_{T}R(L(t),T(t+τ))+δ_{T}ξ_{L}R(F(t),L(t+τ))+ξᵣR(F(t),L(t+τ))+δ_{L}ξᵣR(F(t),T(t+τ))+ξ_{L}ξᵣR(F(t),F(t+τ) (3).

As the maximum values of correlation functions of the self-correlation parts (i.e., R(T(t),T(t+τ)), R(L(t),L(t+τ)) and R(F(t),F(t+τ))) of the several vibrations appear at the time delay zero point, the self-correlation parts of the several vibrations may be removed from the correlation function as shown in Formula (3), thus the above formula may be simplified as:

Rᵣ(x(t),z(t+τ))=(1+δ_{L}δ_{T})R(L(t),T(t+τ))+(ξᵣ+δ_{T}ξₖ)R(F(t),L(t+τ))+(ξ_{L}+δ_{L}ξᵣ)R(F(t),F(t+τ)) (4).

After analysis of factors in Formula (4), it may be found that the maximum peak of Rᵣ(r(t),z(t+τ)) is primarily contributed to R(L(t),T(t+τ)) because δ_{L}, δ_{T}, ξ_{L} and ξᵣ are all less than 1.

According to the theory of correlation, the position τ of the peak is a time difference caused by a difference between the propagation velocity of a transverse signal and the propagation velocity of a longitudinal wave signal. Suppose the propagation velocity of the longitudinal wave L(t) is V_{L} and the propagation velocity of the transverse waves F(t) and T(t) is V_{T}, as the wave velocity of the longitudinal wave is larger than that of the transverse waves, the following formula is satisfied:

$$τ = l \cdot ( \frac{1}{{V}_{T}} - \frac{1}{{V}_{L}} ) , \qquad ( 5 )$$

where, l is a distance from a sound source to a signal pickup point.

With respect to acquisition points on two sides of a leak point, the two acquisition points are supposed as acquisition point 1 and acquisition point 2, respectively, the relation between the time delay r; at the peak of the correlation function Rᵣ(xᵢ(t),zᵢ(t)) the wave velocity and the distance may be expressed by the following formula:

$${τ}_{i} = {l}_{i} \cdot ( \frac{1}{{V}_{T}} - \frac{1}{{V}_{L}} ) , \qquad ( 6 )$$

where, i=1,2, i is corresponding to the acquisition point 1 or the acquisition point 2 respectively when i is equal to 1 or 2, and l₁ is a distance from an acquisition point i to the leak point.

According to the theory of correlation analysis, the correlation function R(xᵢ(t),xᵢ(t+τ)) (i≠j) of axial vibration signals at different acquisition points may be expressed by the following formula:

R(xᵢ(t),xⱼ(t+τ))=R(Lᵢ(t),Lⱼ(t+τ))+δ_{L}²R(Tᵢ(t),Tⱼ(t+τ))+ξ_{L}²R(Fᵢ(t),Fⱼ(t+τ))+δ_{L}R(Lᵢ(t),Tⱼ(t+τ))+ξ_{L}R(Lᵢ(t),Fⱼ(t+τ))+δ_{L}R(Tᵢ(t),Lⱼ(t+τ))+δ_{L}ξ_{L}R(Tᵢ(t),Fⱼ(t+τ))+ξ_{L}R(Fᵢ(t),Lⱼ(t+τ))+ξ_{L}δ_{L}R(Fᵢ(t),Tⱼ(t+τ)) (7).

After analysis of factors in Formula (7), it may be found that the dominant term of the cross-correlation function R(xᵢ(t),xⱼ(t+τ)) of the axial vibration signals at different acquisition points is R(Lᵢ(t),Lⱼ(I+τ)), that is, the maximum peak is primarily contributed to R(Lᵢ(t),Lⱼ(t+τ)). The time delay τ_{Lij} at the peak is the time delay caused by a difference between distances of the longitudinal wave L(t) propagated to the two acquisition points, and the relation of the time delay, the wave velocity and the positions of the acquisition points is as follows:

|τ_{Lij}|=|lᵢ−lⱼ|/V_{L} (8).

According to the theory of correlation analysis, the correlation function R(zᵢ(t),zⱼ(r+τ)) (i≠j) of radial vibration signals at different acquisition points may be expressed by the following formula:

R(zᵢ(t),zⱼ(t+τ))=R(Tᵢ(t),Tⱼ(t+τ))+δ_{T}²R(Lᵢ(t),Lⱼ(t+τ))+ξᵣ²R(Fᵢ(t),Fⱼ(t+τ))+δ_{T}R(Tᵢ(t),Lⱼ(t+τ))+ξᵣR(Tᵢ(t),Fⱼ(t+τ))+δ_{T}R(Lᵢ(t),Tⱼ(t+τ))+δ_{T}ξᵣR(Lᵢ(t),Fⱼ(t+τ))+ξᵣR(Fᵢ(t),Tⱼ(t+τ))+ξᵣδ_{T}R(Fᵢ(t),Lⱼ(t+τ)) (9).

After analysis of factors in Formula (9), it may be found that the dominant term of the cross-correlation function R(zᵢ(t),zⱼ(t+τ)) of the radial vibration signals at different acquisition points is R(Tᵢ(t),Tⱼ(t+τ)), that is, the maximum peak is primarily contributed to R(Tᵢ(t),Tⱼ(t+τ)). The time delay τ_{Tij} at the peak is the time delay caused by a difference between distances of the transverse wave T(t) propagating to the two acquisition points, and the relation of the time delay, the wave velocity and the positions of the acquisition points is as follows:

|τ_{Tij}|=|lᵢ−lⱼ|/V_{T} (10).

As to the positions of acquisition point 1 and 2 being determined from (6), combining Formula (6), Formulae (8) and (10) may obtain the following system of equations:

$$\{ \begin{matrix}{τ}_{1} = {l}_{1} \cdot ( \frac{1}{{V}_{T}} - \frac{1}{{V}_{L}} ) \\ {τ}_{2} = {l}_{2} \cdot ( \frac{1}{{V}_{T}} - \frac{1}{{V}_{L}} ) \\ \vert {τ}_{L 12} \vert = \vert ( {l}_{1} - {l}_{2} ) \vert / {V}_{L} \\ \vert {τ}_{T 12} \vert = \vert ( {l}_{1} - {l}_{2} ) \vert / {V}_{T}\end{matrix} . \qquad ( 11 )$$

Actually it is known that, when l₁>l₁, τ_{L12}<0 and τ_{T12}<0; or otherwise, when l₁<1, τ_{L12}>0 and τ_{T12}>0. Therefore, the system of equations (11) may be expressed as:

$$\{ \begin{matrix}{τ}_{1} = {l}_{1} \cdot ( \frac{1}{{V}_{T}} - \frac{1}{{V}_{L}} ) \\ {τ}_{2} = {l}_{2} \cdot ( \frac{1}{{V}_{T}} - \frac{1}{{V}_{L}} ) \\ {τ}_{L 12} {V}_{L} + {l}_{1} - {l}_{2} = 0 \\ {τ}_{T 12} {V}_{T} + {l}_{1} - {l}_{2} = 0\end{matrix} . \qquad ( 12 )$$

It may be seen from the system of equations (12) that τ_{L12}, τ_{T12}, τ₁ and τ₂ may be calculated according to the outputs of the sensing devices, V_{L}, V_{V}, l₁ and l₂ are unknown and may be solved by the four equations in this system, where both l₁ and l₂ may be used for accurately locating the position of the leak point.

Although the system of equations has been well designed, the inventor(s) finds during verification thereof that, due to the linear correlation of the first and second formulae in the system of equations (12), the determined solution that can be generated by the system of equations (12) can only be zero, which is obviously not accord with actual situations; otherwise, there will be infinite sets of solutions obtained according to the system of equations (12). It is indicated that the unknown monitoring distance cannot be completely solved by using the above time delay values only. Hence, the inventor (s) further makes improvements to the system of equations (12). Based on the actual situation, it may be found that l₁ and l₂ satisfy the following relation:

l₁+l₂=L (13),

where, L is a distance between two acquisition points on two sides of the leak point.

The system of equations (12) and the equation (13) may be combined to obtain the following system of equations:

$$\{ \begin{matrix}{τ}_{L 12} {V}_{L} + {l}_{1} - {l}_{2} = 0 \\ {τ}_{T 12} {V}_{T} + {l}_{1} - {l}_{2} = 0 \\ {τ}_{2} {l}_{1} - {τ}_{1} {l}_{2} = 0 \\ {l}_{1} + {l}_{2} = L\end{matrix} . \qquad ( 14 )$$

For purpose of verification, the system of equations (14) may be converted into the following matrix form:

$$( \begin{matrix}{τ}_{L 12} & 0 & 1 & - 1 \\ 0 & {τ}_{T 12} & 1 & - 1 \\ 0 & 0 & {τ}_{2} & - {τ}_{1} \\ 0 & 0 & 1 & 1\end{matrix} ) ( \begin{matrix}{V}_{L} \\ {V}_{T} \\ {l}_{1} \\ {l}_{2}\end{matrix} ) = ( \begin{matrix}0 \\ 0 \\ 0 \\ L\end{matrix} ) . \qquad ( 15 )$$

Suppose the determinant of the matrix (15) is D, then:

$$D = \vert \begin{matrix}{τ}_{L 12} & 0 & 1 & - 1 \\ 0 & {τ}_{T 12} & 1 & - 1 \\ 0 & 0 & {τ}_{2} & - {τ}_{1} \\ 0 & 0 & 1 & 1\end{matrix} \vert = {τ}_{L 12} {τ}_{T 12} ( {τ}_{1} + {τ}_{2} ) . \qquad ( 16 )$$

It may be seen from the determinant (16) that, when D≠0, the linear system of equations (14) has a unique solution; and, when D=0, the linear system of equations (14) may have no solution or multiple solutions.

In combination with the actual situation and upon the analysis of data, the inventor(s) finds that D≠0 and D=0 exactly reflect two position states of the sensors relative to a leak point. That is, when D≠0, the leak point is located at a position between the acquisition point 1 and the acquisition point 2, neither a middle point nor an end point; and, when D=0, the leak point, the acquisition point 1 and the acquisition point 2 are at a same position, or otherwise the leak point is located at a middle point between the acquisition point 1 and the acquisition point 2. Therefore, the following conclusion is obtained:

to make D≠0 satisfied, τ_{L12}≠0, τ_{T12}≠0 and τ₁+τ₂≠0 should be satisfied simultaneously. In this case, the system of equations (14) has the following solutions:

$$\{ \begin{matrix}{V}_{L} = \frac{( {τ}_{2} - {τ}_{1} ) L}{( {τ}_{1} + {τ}_{2} ) {τ}_{L 12}} \\ {V}_{T} = \frac{( {τ}_{2} - {τ}_{1} ) L}{( {τ}_{1} + {τ}_{2} ) {τ}_{T 12}} \\ {l}_{1} = \frac{{τ}_{1} L}{{τ}_{1} + {τ}_{2}} \\ {l}_{2} = \frac{{τ}_{2} L}{{τ}_{1} + {τ}_{2}}\end{matrix} . \qquad ( 17 )$$

Then, the specific position of the leak point may be found by l₁ and l₂.

When any one of τ_{L12}=0, τ_{T12}=0 and τ₁+τ₂=0 is satisfied, D=0, and the system of equations (14) may have no solution or multiple solutions in this case. However, according to the physical meanings of the wave velocity and time delay, the position of the leak position may still be found by the following method:

if τ_{L12}=0, τᵣ₁₂=0 and τ₁+τ₂≠0, the leak point is located at a middle point between the two acquisition points, that is, the distance from the leak point to any one of the acquisition points is L/2; if τ₁+τ₂=0, this situation may occurs just when the positions of the two acquisition points are coincided, and in this case, the leak point, the acquisition point 1 and the collection 2 are at a same position (during the actual operating, there may be a situation that two acquisition points are arranged at a same position; and in this case, the distance between the two sensing devices may be regarded as 0).

After the use of the method and device for leak location for fluid pipelines provided by the present invention, the position of a leak point may be found by performing simple calculation according to the detected data output from the sensing devices, with low algorithm processing complexity, quick system response speed, and high location accuracy of the leak detection device; meanwhile, as there is no need to acquire the propagation velocity of an acoustic vibration signal in a pipeline and instead the propagation velocity of the acoustic vibration signal may be solved, the location error caused by different acoustic propagation velocities in different pipelines may be avoided. Therefore, the method and device provided by the present invention are particularly suitable for leak detection for pipelines with a large length.

The present invention has the advantages of high location accuracy without needing to know the wave velocity of acoustic vibrations of a pipeline, and low processing complexity; and the acoustic velocity of longitudinal wave and the acoustic velocity of transverse wave of the pipeline can be measured actually.

### BRIEF DESCRIPTION OF THE DRAWINGS

FIG. 1 is a schematic diagram of a device for leak location for fluid pipelines.

### DETAILED DESCRIPTION OF THE PRESENT INVENTION

A method for leak detection and location for fluid pipelines is provided, including a pipeline to be detected, characterized in that the pipeline to be detected is at least provided with two sensing devices having a certain distance there between, acquisition points are formed at the positions of the sensing devices, and the sensing devices can simultaneously sense acoustic vibrations of the pipeline in two directions, i.e., axial direction and radial direction of the pipeline, respectively; when there is a leak point in the pipeline to be detected between the two acquisition points, locating the leak point is performed according to the following methods:

suppose the two acquisition points are respectively acquisition point 1 and acquisition point 2, a distance between the two acquisition points is L, a distance from the acquisition point 1 to the leak point is l₁, a distance from the acquisition point 2 to the leak point is l₂, the propagation velocity of a longitudinal wave signal in the pipeline to be detected is V_{L}, and the propagation velocity of a transverse wave signal in the pipeline to be detected is V_{T}; the output of the sensing devices contains radial acoustic vibration signals and axial acoustic vibration signals, a time delay value of a maximum peak other than a time delay zero point of a cross-correlation function of a radial acoustic vibration signal and an axial acoustic vibration signal corresponding to the acquisition point 1 is τ₁, a time delay value of a maximum peak other than a time delay zero point of a cross-correlation function of a radial acoustic vibration signal and an axial acoustic vibration signal corresponding to the acquisition point 2 is τ₂, a time delay value of a maximum peak of a cross-correlation function of axial acoustic vibration signals of the two acquisition points is τ_{L12}, and a time delay value of a maximum peak of a cross-correlation function of radial acoustic vibration signals of the two acquisition points is τ_{T12}; and, the L is already known;

when τ_{L12}≠0, τᵣ₁₂≠0 and τ₁+τ₂≠0 are satisfied simultaneously, the position of the leak point is found according to the following methods:

V_{L}, V_{T}, l₁ and l₂ are solved by using the following system of equations:

$$\{ \begin{matrix}{τ}_{L 12} {V}_{L} + {l}_{1} - {l}_{2} = 0 \\ {τ}_{T 12} {V}_{T} + {l}_{1} - {l}_{2} = 0 \\ {τ}_{2} {l}_{1} - {τ}_{1} {l}_{2} = 0 \\ {l}_{1} + {l}_{2} = L\end{matrix} ;$$

after V_{L}, V_{T}, l₁ and l₂ are solved, the position of the leak point may be found according to l₁ and l₂;

when any one of τ_{L12}=0, τ_{T12}=0 and τ₁+τ₂=0 is satisfied, the position of the leak point is found according to the following methods:

if τ_{L12}=0, τ_{T12}=0 and τ₁+τ₂≠0, the leak point is located at a middle point between the two acquisition points; if τ₁+τ₂=0, it is indicated that the distance between the two sensing devices is 0, and the leak point, the acquisition point 1 and the collection 2 are at a same position.

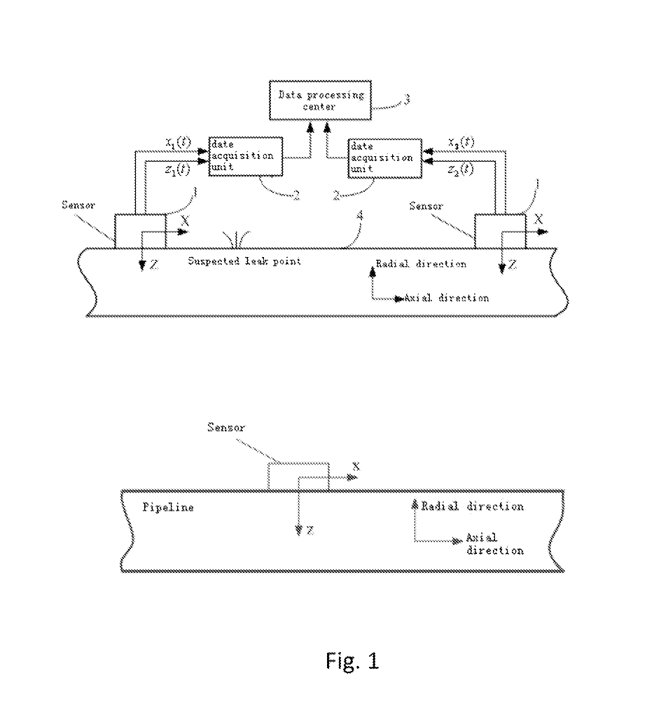

The present invention provides a device for leak location for fluid pipelines. As shown in FIG. 1, the device is provided with sensors 1, data acquisition units 2 and a data processing center 3. When the sensors 1 are dual-axis acoustic/vibration sensors, the two sensing directions of each of the sensors 1 are perpendicular to each other, wherein the first sensing direction X is parallel to the axial direction of a pipeline 4, the second sensing direction Z is parallel to the radial direction of the pipeline 4, and the sensors 1 are electrically connected to the data acquisition units 2 one to one. When the sensors 1 are acoustic/vibration sensors, every two acoustic/vibration sensors 1 are arranged at one point in the pipeline 4, that is, form an acquisition point, and at each acquisition point: the sensing direction of one of the acoustic/vibration sensors 1 is brought to be parallel to the axial direction of the pipeline, and the sensing direction of the other one of the acoustic/vibration sensors 1 is brought to be parallel to the radial direction of the pipeline, and the two sensors 1 at each of the acquisition points are electrically connected to one data acquisition unit 2 correspondingly. The data acquisition units 2 may be in wired communication with the data processing center 3 via a wired network or in wireless communication with the data processing center 3 via a wireless network. The sensors 1, the data acquisition units 2 and the data processing center 3 described above constitute one set of device for leak location for pipelines.

The sensors 1 are used for acquiring an axial vibration signal xᵢ(t) and a radial vibration signal zᵢ(t) caused by the leakage of the fluid pipeline 4, where i=1,2 is respectively corresponding to two acquisition points (the acquisition points are formed at the positions of the sensors 1). In this way, the sensors 1 at the two collection sensors may acquire two pairs of axial vibration signals x₁(t) and x₂(t) and radial vibration signals z₁(t) and z₂(t).

The data acquisition units 2 are used for converting analog signals output from the sensors 1 into digital signals and then sending the digital signals to the data processing center 3 over a wired network or wireless network.

The data processing center 3 performs correlation processing for the two pairs of axial vibration signals x₁(t) and x₂(t) and radial vibration signals z₁(t) and z₂(t) sent from the two data acquisition units 2 according to the location principle described in the present invention. That is, the data processing center 3 performs correlation processing for four sets of data (i.e., x₁(t), x₂(t); z₁(t), z₂(t); x₁(t), z₁(t); and, x₂(t) z₂(t)) to form four sets of cross-correlation functions. Upon the analysis and calculation of the four sets of cross-correlation functions, four time delay values (i.e., τ_{L12}, τ_{T12}, τ₁ and τ₂) may be obtained. Thus, the position of the leak point may be determined by the four time delay values and the distance L between the two acquisition points in accordance with the location method provided by the present invention, and the acoustic velocity of the longitudinal wave and the acoustic velocity of the transverse wave may be calculated.

We claim:

1. A method for leak detection and location for fluid pipelines, comprising a pipeline to be detected, characterized in that the pipeline to be detected is at least provided with two sensing devices having a certain distance there between, acquisition points are formed at the positions of the sensing devices, and the sensing devices can simultaneously sense acoustic vibrations of the pipeline in two directions, i.e., axial direction and radial direction of the pipeline, respectively; when there is a leak point in the pipeline to be detected between the two acquisition points, locating the leak point is performed according to the following methods:
suppose the two acquisition points are respectively acquisition point 1 and acquisition point 2, a distance between the two acquisition points is L, a distance from the acquisition point 1 to the leak point is l₁, a distance from the acquisition point 2 to the leak point is l₂, the propagation velocity of a longitudinal wave signal in the pipeline to be detected is V_{L}, and the propagation velocity of a transverse wave signal in the pipeline to be detected is V_{T}; the outputs of the sensing devices contains radial acoustic vibration signals and axial acoustic vibration signals, a time delay value of a maximum peak other than a time delay zero point of a cross-correlation function of a radial acoustic vibration signal and an axial acoustic vibration signal corresponding to the acquisition point 1 is τ₁, a time delay value of a maximum peak other than a time delay zero point of a cross-correlation function of a radial acoustic vibration signal and an axial acoustic vibration signal corresponding to the acquisition point 2 at is τ₂, a time delay value of a maximum peak of a cross-correlation function of axial acoustic vibration signals of the two acquisition points is τ_{L12}, and a time delay value of a maximum peak of a cross-correlation function of radial acoustic vibration signals of the two acquisition points is τ_{T12}; and, L is already known;
when τ_{L12}≠0, τ_{T12}≠0 and τ₁+τ₂≠0 are satisfied simultaneously, the position of the leak point is found according to the following methods:
V_{L}, V_{T}, l₁ and l₂ are solved by using the following system of equations:
$$\{ \begin{matrix}{τ}_{L 12} {V}_{L} + {l}_{1} - {l}_{2} = 0 \\ {τ}_{T 12} {V}_{T} + {l}_{1} - {l}_{2} = 0 \\ {τ}_{2} {l}_{1} - {τ}_{1} {l}_{2} = 0 \\ {l}_{1} + {l}_{2} = L\end{matrix} ;$$
after V_{L}, V_{T}, l₁ and l₂ are solved, the position of the leak point may be found according to l₁ and l₂;
when any one of τ_{L12}=0, τ_{T12}=0 and τ₁+τ₂=0 is satisfied, the position of the leak point is found according to the following methods:
if τ_{L12}=0, τ_{T12}=0 and τ₁+τ₂≠0, the leak point is located at a middle point between the two acquisition points; if τ₁+τ₂=0, it is indicated that the distance between the two sensing devices is 0, and the leak point, the acquisition point 1 and the collection 2 are at a same position.
